(19) United States
(12) Patent Application Publication
(10) Pub. No.: US 2025/0201031 A1
(43) Pub. Date: Jun. 19, 2025

(54) VEHICLE GATEWAY WITH POWER MANAGEMENT SYSTEM

(71) Applicant: MOTIVE TECHNOLOGIES, INC., San Francisco, CA (US)

(72) Inventors: Scott Alan MORFORD, Dakota Dunes (SD); Amish Rajesh BABU, Los Altos, CA (US); George Winchester CRUM, III, Sterling, VA (US); Jack Hood PROFIT, JR., Vashon, WA (US); Joseph Norman PULVER, Tonawanda, NY (US); Carsten Flemming JENSEN, San Francisco, CA (US)

(21) Appl. No.: 18/539,962

(22) Filed: Dec. 14, 2023

(51) Int. Cl. G07C 5/00; B60L 58/16; G07C 5/08

(52) U.S. Cl. CPC G07C 5/008; B60L 58/16; G07C 5/0808

(57) ABSTRACT

In some implementations, the techniques described herein relate to a system including: a vehicle interface adapter, the vehicle interface adapter communicatively connected to a diagnostic port of a vehicle via a first cable; and a vehicle gateway, the vehicle gateway communicatively coupled to the vehicle interface adapter via a second cable, wherein the vehicle interface adapter is configured to receive vehicle data via the first cable, packetize the vehicle data into vehicle packets, and transmit the vehicle packets to the vehicle gateway, and the vehicle gateway is configured to receive the vehicle packets and manage a power state of the system.

### BACKGROUND

Modern vehicles generate significant amounts of digital data during operation and, in some scenarios, while not operating. Current systems attempt to access and process this data by reading the data directly from vehicle ports, such as an on-board diagnostics (OBD) port.

### BRIEF DESCRIPTION OF THE DRAWINGS

FIG. 1 is a block diagram of a vehicle gateway (VG) and supporting hardware according to some of the disclosed embodiments.

FIG. 2 is a block diagram illustrating a cable for connecting a vehicle interface adapter (VIA) to a diagnostic port according to some of the disclosed embodiments.

FIG. 3 is a block diagram illustrating a vehicle interface adapter according to some of the disclosed embodiments.

FIG. 4 is a block diagram illustrating a vehicle gateway according to some of the disclosed embodiments.

FIG. 5 is a flow diagram illustrating a method for initializing a vehicle interface adapter and transmitting data to a vehicle gateway according to some of the disclosed embodiments.

FIG. 6 is a state diagram illustrating power states of a vehicle gateway and transitions between such states.

FIG. 7 is a flow diagram, illustrating a method for a transitioning a vehicle gateway from a full power state to a standby state, according to some of the disclosed embodiments.

FIG. 8 is a flow diagram, illustrating a method for transitioning a vehicle gateway, from a standby state to more other states, according to some of the disclosed embodiments.

FIG. 9 is a block diagram of a computing device according to some embodiments of the disclosure.

### DETAILED DESCRIPTION

In some implementations, the techniques described herein relate to a system including: a vehicle interface adapter, the vehicle interface adapter communicatively connected to a diagnostic port of a vehicle via a first cable; and a vehicle gateway, the vehicle gateway communicatively coupled to the vehicle interface adapter via a second cable, wherein the vehicle interface adapter is configured to receive vehicle data via the first cable, packetize the vehicle data into vehicle packets, and transmit the vehicle packets to the vehicle gateway, and the vehicle gateway is configured to receive the vehicle packets and manage a power state of the system.

In some implementations, the techniques described herein relate to a system, wherein the first cable includes a first end, the first end including a pinout for the vehicle interface adapter and a second end, the second end selected based on a type of the diagnostic port.

In some implementations, the techniques described herein relate to a system, wherein the second cable includes a universal serial bus cable.

In some implementations, the techniques described herein relate to a system, wherein the first cable includes a detection integrated circuit configured to detect a type of the diagnostic port and transmit a signal to the vehicle interface adapter representing the type of the diagnostic port.

In some implementations, the techniques described herein relate to a system, wherein the detection integrated circuit includes a fixed value set based on the type of the diagnostic port.

In some implementations, the techniques described herein relate to a system, wherein the detection integrated circuit includes program logic to analyze signals received via the diagnostic port to identify the type of the diagnostic port.

In some implementations, the techniques described herein relate to a system, further including a universal serial bus (USB) hub, the USB hub communicatively coupled to the vehicle interface adapter and the vehicle gateway, wherein the vehicle gateway acts a USB host.

In some implementations, the techniques described herein relate to a system, wherein the vehicle gateway is configured to manage a power state of the system by transitioning the vehicle gateway among a plurality of power states including a full power state, low power state, standby state and power off state.

In some implementations, the techniques described herein relate to a system, wherein the vehicle gateway is configured to perform an action received from a network while in the standby state.

In some implementations, the techniques described herein relate to a system, wherein the vehicle gateway is configured to transition from the standby state to the full power state in response to an inertial measurement unit (IMU) event or a USB wake event.

In some implementations, the techniques described herein relate to a method including: operating a vehicle gateway in a full power state; detecting a change in an operating status of a vehicle communicatively coupled to the vehicle gateway; transitioning the vehicle gateway to a low power state based on the change in the operating status; transitioning the vehicle gateway to a standby stage after a timer expires; receiving, by the vehicle gateway, a trigger signal while in the standby state; and transitioning to one of a full power state or action state in response to the trigger signal.

In some implementations, the techniques described herein relate to a method, wherein said detecting a change in vehicle operating status includes detecting a vehicle ignition status or monitoring a health of a battery through a diagnostic port.

In some implementations, the techniques described herein relate to a method, wherein the trigger signal includes one or more of: a USB wake signal, an LTE signal, or an IMU sensor trigger indicating movement of the vehicle.

In some implementations, the techniques described herein relate to a method, wherein transitioning the vehicle gateway to a standby stage after a timer expires further includes confirming that an action was not detected before the timer expires.

In some implementations, the techniques described herein relate to a method, wherein transitioning to the action state includes performing an action included in a command received via a network interface.

In some implementations, the techniques described herein relate to a non-transitory computer-readable storage medium for tangibly storing computer program instructions capable of being executed by a computer processor, the computer program instructions defining steps of: operating a vehicle gateway in a full power state; detecting a change in an operating status of a vehicle communicatively coupled to the vehicle gateway; transitioning the vehicle gateway to a low power state based on the change in the operating status; transitioning the vehicle gateway to a standby stage after a timer expires; receiving, by the vehicle gateway, a trigger signal while in the standby state; and transitioning to one of a full power state or action state in response to the trigger signal.

In some implementations, the techniques described herein relate to a non-transitory computer-readable storage medium, wherein said detecting a change in vehicle operating status includes detecting a vehicle ignition status or monitoring a health of a battery through a diagnostic port.

In some implementations, the techniques described herein relate to a non-transitory computer-readable storage medium, wherein the trigger signal includes one or more of: a USB wake signal, an LTE signal, or an IMU sensor trigger indicating movement of the vehicle.

In some implementations, the techniques described herein relate to a non-transitory computer-readable storage medium, wherein transitioning the vehicle gateway to a standby stage after a timer expires further includes confirming that an action was not detected before the timer expires.

In some implementations, the techniques described herein relate to a non-transitory computer-readable storage medium, wherein transitioning to the action state includes performing an action included in a command received via a network interface.

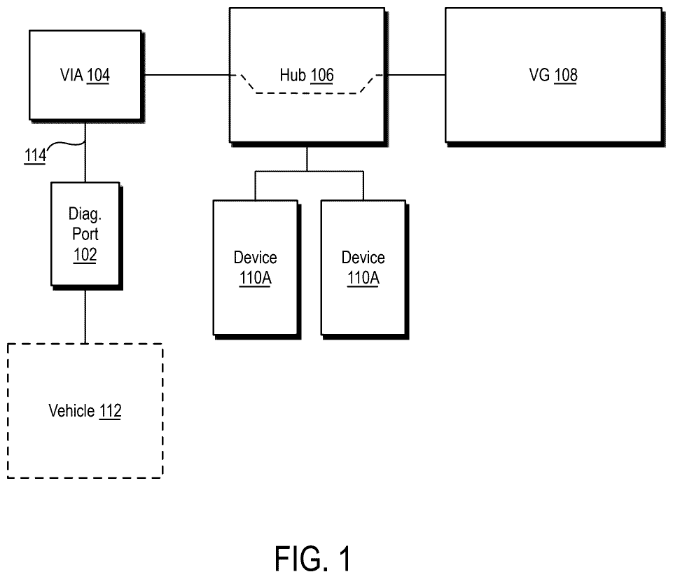

FIG. 1 is a block diagram of a vehicle gateway (VG) and supporting hardware according to some of the disclosed embodiments.

The system of FIG. 1 may be communicatively coupled to a vehicle 112. In some implementations, vehicle 112 may include a diagnostic port 102.

The diagnostic port 102 may comprise a connection point for diagnostic tools and equipment to access and analyze the onboard systems of a vehicle. In some implementations, the type of diagnostic port present in a vehicle depends on the make, model, and year of vehicle 112. One common type of diagnostic port is the OBD-II (On-Board Diagnostics II) port. This port is standardized and mandated by law in most vehicles manufactured after 1996. The OBD-II port is usually located under the dashboard on the driver's side of the vehicle. It is equipped with a 16-pin connector and is compatible with a variety of diagnostic tools. The OBD-II port provides access to a wide range of diagnostic information, such as engine performance, emission levels, and sensor data. Another type of diagnostic port 102 is a J1939 port, which is primarily used in heavy-duty vehicles and off-highway equipment. J1939 allows for communication between various vehicle components and provides diagnostic capabilities for monitoring and troubleshooting. Another type of diagnostic port 102 is an ISO 9141-2 port, which is commonly found in older vehicles. It provides a standardized communication interface for diagnostic systems, allowing for the retrieval of fault codes and other diagnostic information. While automobiles are primarily discussed, the disclosure is not limited as such, in some implementations, vehicle 112 can comprise any object that can transport persons, such as boat, airplane, bicycle, etc. As such, diagnostic port 102 may comprise other non-automotive ports such as an NMEA 2000 port which is widely used for diagnostic purposes in maritime vessels and enables communication between various marine electronic devices, such as engines, navigation systems, and sensors, allowing for real-time monitoring and diagnostics.

The system further includes a cable 114 that connects diagnostic port 102 to a vehicle interface adapter, VIA 104. In some implementations, VIA 104 comprises a small electronic device configured to provide a uniform interface to multiple types of diagnostic ports. As such, a singly designed VIA can be utilized with multiple types of diagnostic ports (not illustrated). In some implementations, cable 114 can comprise a cable having a first end that is designed to conform to the specifications of diagnostic port 102. For example, one end of cable 114 can comprise an OBD-II pinout. In some implementations, cable 114 can have a second end that is designed to conform to the specifications of VIA 104. In some implementations, a manufacturer can thus manufacture multiple types of cables, each cable having one end conforming to the VIA 104 pinout while the other end is manufactured to the standards of different diagnostic port pinouts. In contrast to other systems, cable 114 comprises the only component of the system that is designed to meet the requirements of vehicle 112. That is, other systems require connected devices to handle multiple types of diagnostic ports. This necessarily increases the complexity and rigidity of such devices. By contrast, the illustrated system only requires a custom cable that can be quickly and cheaply manufactured.

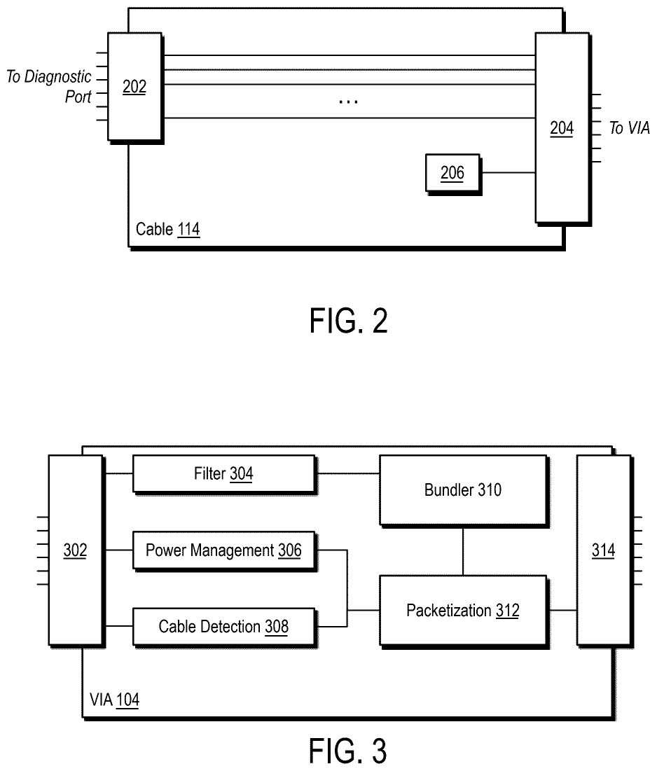

VIA 104 comprises a computing device that is communicatively coupled to diagnostic port 102 via cable 114 and to a vehicle gateway, VG 108, via a single interface. In some implementations, as illustrated, VIA 104 can optionally be connected to VG 108 via a Universal Serial Bus (USB) hub 106. Various details of cable 114, VIA 104, and VG 108 are discussed more fully in FIGS. 2 through 4, respectively, and only a high-level description of those components is provided herein.

In brief, VIA 104 provides protocol handling and power management for the system. VIA 104 is configured with circuitry and/or software for detecting the type of cable 114 and pre-loading firmware to process port-specific data formats into a unified data format for downstream processing. VIA 104 is further capable of finalizing the selection of firmware based on reading data from the diagnostic port 102 and confirming or adjusting the protocol in use. In this manner, VIA 104 can be communicatively coupled to any diagnostic port that has an associated cable. For example, VIA 104 can be coupled to an OBD-II port or J1939 port, provided the proper cable is used to connect VIA 104 to diagnostic port 102. VIA 104 further includes firmware and/or circuitry to lightly pre-process the data coming off the vehicle. This pre-processing can include filtering irrelevant or unnecessary data, bundling or windowing data to reduce the total number of transfers, and packetizing the data into a standard format. In some implementations, this standard format may include a USB formatted packet. VIA 104 can also include power management circuitry which may work in conjunction with VG 108 to manage the overall power states of the system. Specifically, VIA 104 may include firmware and/or circuitry to detect the power state of the vehicle, monitor vehicle battery health, etc. and provide this information to VG 108 for further processing or may perform pre-emptive power management operations.

As illustrated, VIA 104 is ultimately communicatively coupled to VG 108. In some implementations, these two devices can be connected via a USB connection. In some implementations, this USB connection can be a wired connection. In other implementations, the VIA 104 and VG 108 can be wireless connected via a short-range wireless network (e.g., IEEE 802.11, Bluetooth, etc.). In some implementations, VIA 104 transmits packetized vehicle data to VG 108 for further processing. In some implementations, VIA 104 transmits USB packets over a wired connection to VG 108. In some implementations, each of these packets can include one item of vehicle data. Alternatively, or in conjunction with the foregoing, VIA 104 may transmit packets that include multiple frames of vehicle data to VG 108.

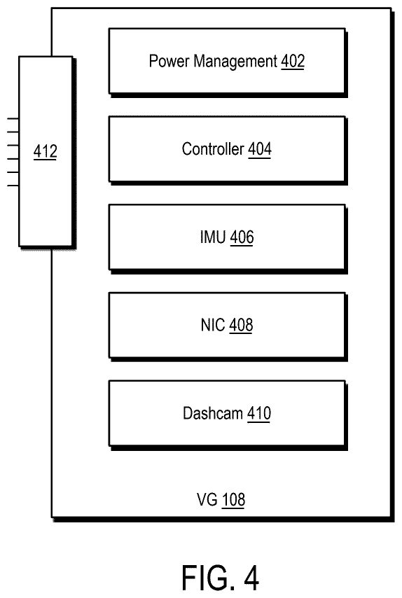

VG 108 may perform various operations described more fully in FIG. 4. In general, VG 108 can be configured to act as an exterior-facing or interior-facing dashcam device. In some implementations, VG 108 can include both an exterior- and interior-facing camera and the number of cameras is not limiting. In some implementations, the VG 108 can include a network interface chip (NIC) such as a cellular transceiver or similar type of transceiver for receiving data from a remote data source (e.g., central management server). In some implementations, VG 108 can also include an inertial measurement unit (IMU) which can be used to determine when the VG 108 and/or vehicle 112 are in motion and can further be used to determine velocity, acceleration, and other movement parameters of the vehicle 112. VG 108 may further include a central processing unit (CPU) or controller to receive data from VIA 104, process such data, and control the various sub-units of the device. VG 108 may also include a power management circuit (PMC). This PMC may be implemented separately from the controller or may be integrated into the controller. In general, the PMC may manage the power of the VG 108 as well as other devices (e.g., hub 106, VIA 104, etc.). In some implementations, the PMC may coordinate with VIA 104 to manage power for the entire system.

As illustrated, in some arrangements, the system may include a hub 106. In some implementations, this hub 106 is optional. If implemented, hub 106 can comprise a USB hub. In some implementations, a USB hub can perform operations of facilitating communication between multiple USB-enabled devices (e.g., device 110A and device 100B) and a host device. In some implementations, VG 108 is configured to act as the USB host device. In such implementations, the USB hub acts as a central connection point which expands a single USB port on the host system (e.g., VG 108) into several ports, allowing multiple devices (e.g., device 110A, device 100B) to be connected to the host system simultaneously.

Furthermore, the USB hub can manage the data traffic between the host system and the connected devices, ensuring that data packets reach their intended destinations without conflicts or interference. This management can include operations such as buffering data, managing data transfer rates, and handling error correction to ensure reliable communication. The USB hub may also have the capability to provide power to the connected devices. This can be beneficial in scenarios where the devices require power for operation but may not have their own power sources. The power supplied by the hub can be either through standard USB power delivery or via enhanced power delivery mechanisms, which may be necessary for devices with higher power requirements.

In some implementations, communications between each of the components depicted in FIG. 1, and the following figures, may be bi-directional.

FIG. 2 is a block diagram illustrating a cable for connecting a VIA to a diagnostic port according to some of the disclosed embodiments.

As illustrated, cable 114 includes two ends or ports: first end 202 and second end 204. In some implementations, first end 202 includes a pinout that matches a diagnostic port of a vehicle. In some implementations, second end 204 includes a pinout that matches the input port of the VIA. As illustrated within cable 114, some or all pins of first end 202 may pass through to output pins of second end 204, thus acting as a signal path from the diagnostic port of the vehicle to the VIA. In some implementations, the number of passthrough wires is not limiting but may be selected based on the maximum size of a pinout supported by the system.

In some implementations, the physical design of the connectors (first end 202, second end 204) may be ergonomically designed to ensure ease of connection and disconnection, while also minimizing the risk of incorrect insertion. The design might also include keying or coding mechanisms to prevent incorrect mating with incompatible ports.

In some implementations, the cable 114 might also include additional functionality such as built-in signal conditioning circuits to ensure the signals remain within specified levels or to convert signals to a format or voltage level more suitable for processing by the VIA. This can be particularly useful if the diagnostic port and the VIA operate at different voltage levels or signal formats.

Lastly, in certain implementations, cable 114 may also support bi-directional communication, not only carrying signals from the diagnostic port to the VIA but also transmitting signals or commands from the VIA to the diagnostic port. This bi-directional communication capability can be crucial for enabling interactive diagnostic or configuration sessions with the vehicle's systems.

As illustrated, cable 114 can include a detection integrated circuit 206. In some implementations, detection integrated circuit 206 can be a read-only circuit that is configured to provide a diagnostic port identifier to the VIA. For example, the detection integrated circuit 206 may provide a fixed value for identifying various types of diagnostic ports. In some implementations, each cable for a given diagnostic port type can be equipped with a detection integrated circuit 206 that outputs a known value representing the port type. In this scenario, when the cable is connected, the detection integrated circuit 206 communicates this known value to the VIA, identifying the type of diagnostic port connected. The known identifier value could be stored in a read-only memory (ROM) within the detection integrated circuit 206. In some implementations, this value can be transmitted to VIA via the second end.

In other implementations, the detection integrated circuit 206 can include program logic to analyze the signals from first end 202 and automatically detect a potential cable type.

In some implementations, the detection integrated circuit 206 could have onboard logic capable of analyzing the electrical characteristics and/or communication protocols on the lines from the diagnostic port. By analyzing these signals, the detection integrated circuit 206 can determine the type of diagnostic port and communicate this information to the VIA. This could involve measuring voltage levels, impedance, or even decoding initial communication protocols to identify the type of diagnostic port.

Alternatively, or in conjunction with the foregoing, the detection integrated circuit 206 could actively communicate with the diagnostic port to identify its type. This might involve sending specific queries or commands to the diagnostic port and analyzing the responses to determine the port type. This method could allow for a more accurate identification, even in scenarios where multiple diagnostic port types share similar electrical characteristics.

Alternatively, or in conjunction with the foregoing, the detection integrated circuit 206 could employ a passive resonance circuit that resonates at a particular frequency specific to the type of diagnostic port. When the cable is connected, the VIA could send a sweep of frequencies, and the resonance detected can indicate the type of diagnostic port.

Alternatively, or in conjunction with the foregoing, the detection integrated circuit 206 could feature auto-configuration circuits that interact with the diagnostic port to automatically configure its pinout to match that of the diagnostic port. This information is then communicated to the VIA to inform it of the type of diagnostic port connected. This method could provide a highly flexible and adaptable system capable of supporting a wide range of diagnostic port types with a single cable design.

In some implementations, detection integrated circuit 206 can use machine learning algorithms to analyze a range of parameters from the diagnostic port, accurately identifying the port type even in complex or ambiguous scenarios.

In some implementations, the detection integrated circuit 206 can use one, some, or all of the above approaches in combination. If using multiple approaches, the detection integrated circuit 206 can use the outputs to guide its decision on a port type by weighting each decision and determining which is the most likely correct identification. As will be discussed in FIG. 3, the VIA can ultimately make a final decision guided by the detected cable type.

FIG. 3 is a block diagram illustrating a vehicle interface adapter according to some of the disclosed embodiments.

In an implementation, VIA 104 includes two ports, an input port 302 and an output port 314. In some implementations, input port 302 is communicatively coupled to the output port (e.g., second end 204) of a cable (e.g., cable 114) communicatively coupled to a diagnostic port (e.g., diagnostic port 102) of a vehicle (e.g., vehicle 112). As such, data from the vehicle's subsystems are passed through to VIA 104.

In some implementations, vehicle data first passes through a filter 304 which may comprise a software, firmware, or hardware filter. In some implementations, this filter 304 is responsible for reducing the total data size output via output port 314. Indeed, a modern vehicle may produce a significant volume of messages, only some of which are useful for a vehicle gateway (e.g., VG 108). In some implementations, filter 304 can utilize rules and/or machine learning (ML) to drop some messages while passing others through to a bundler 310. For example, a rules-based approach may specify code values that should be passed through and any message not including these codes are dropped. An ML approach can be trained by labeling message examples and predicting which messages are relevant or not.

In some implementations, filter 304 can employ adaptive filtering techniques to dynamically adjust filtering criteria based on real-time conditions or historical data trends. In some implementations, filter 304 could be designed as a multi-stage filtering system, where each stage targets a specific type of data or filtering criterion. In some implementations, filter 304 can incorporate error handling mechanisms to identify, log, and/or correct errors in the incoming data. In some implementations, filter 304 can support customizable filtering profiles, allowing different filtering criteria to be applied based on the needs of specific applications or operational modes of the vehicle. Filter 304 can also include a prioritization mechanism to ensure that critical or high-priority messages are processed and passed through to the next stage in the pipeline promptly, regardless of the filtering criteria.

In some implementations, bundler 310 may comprise a software, firmware, or hardware component that can aggregate messages over a time window. In general, messages from the vehicle may be received one at a time. In some implementations, bundler 310 may accumulate messages over a fixed interval (e.g., one millisecond) to avoid flooding a vehicle gateway with individual messages. Further, such bundling can be used to compress messages and reduce the total bandwidth used per transmission (since vehicle messages may include various repeated bits which can be compressed compactly). In some implementations, however, bundler 310 may be optional.

In some implementations, bundler 310 may employ dynamic time windowing techniques to adjust the interval over which messages are aggregated based on the current data rate, network conditions, or other relevant factors. In some implementations bundler 310 might use a classification system to sort incoming messages into different categories or priority levels before bundling. In some implementations, bundler 310 could attach header information to each bundle, providing metadata about the bundled messages, such as the number of messages, timestamp of the first message, etc. In some implementations, bundler 310 might incorporate mechanisms for verifying the integrity of the bundled data, such as checksums or cryptographic hashes, ensuring that the data has not been altered or corrupted during the bundling process. In some implementations, bundler 310 can have buffer management capabilities to handle situations where incoming data rates temporarily exceed the capacity of the bundling process, ensuring that no messages are lost. In some implementations, bundler 310 may have error recovery mechanisms to handle situations where errors are detected in the bundled data, allowing for the re-transmission or correction of erroneous data.

The output of bundler 310 (or filter 304 if bundler 310 is not implemented) are then passed to a packetization process 312. In some implementations, packetization process 312 can be a software, firmware, or hardware process whereby vehicle data is converted to a packet format suitable for transmission via output port 314. As one example, packetization process 312 can convert vehicle messages to USB packets.

In some implementations, packetization process 312 could incorporate a protocol conversion mechanism, transforming vehicle diagnostic protocols to a format suitable for USB transmission. In some implementations, packetization process 312 might include error-checking codes within each packet, such as cyclic redundancy checks (CRC), to allow for error detection during the USB transmission. In some implementations, packetization process 312 could employ USB-specific encryption techniques to ensure the security and privacy of the data during transmission. In some implementations, packetization process 312 might utilize header compression techniques to reduce the overhead associated with USB packet headers, optimizing the data transmission efficiency over USB. In some implementations, packetization process 312 may support multiple USB packetization schemes, adapting to different data types or communication requirements within the USB framework. In some implementations, packetization process 312 could handle USB packet fragmentation and reassembly, ensuring that large data sets can be transmitted and received accurately over USB. In some implementations, packetization process 312 might have a queuing mechanism to manage the packetization of data in a way that meets the timing or priority requirements of the USB communication. In some implementations, packetization process 312 may include a feedback loop with earlier stages of the data pipeline, allowing for adjustments in USB packetization based on the observed conditions or the requirements of downstream processing stages.

In some implementations, filter 304, bundler 310 and packetization process 312 can be implemented separately or as part of firmware for a microcontroller (not illustrated). In general, filter 304, bundler 310, and packetization process 312 are referred to as the data pipeline of the VIA 104 as they sequentially process vehicle data before transmitting that data to the vehicle gateway.

In addition to the data pipeline, VIA 104 includes a power management circuit 306 and a cable detection circuit 308.

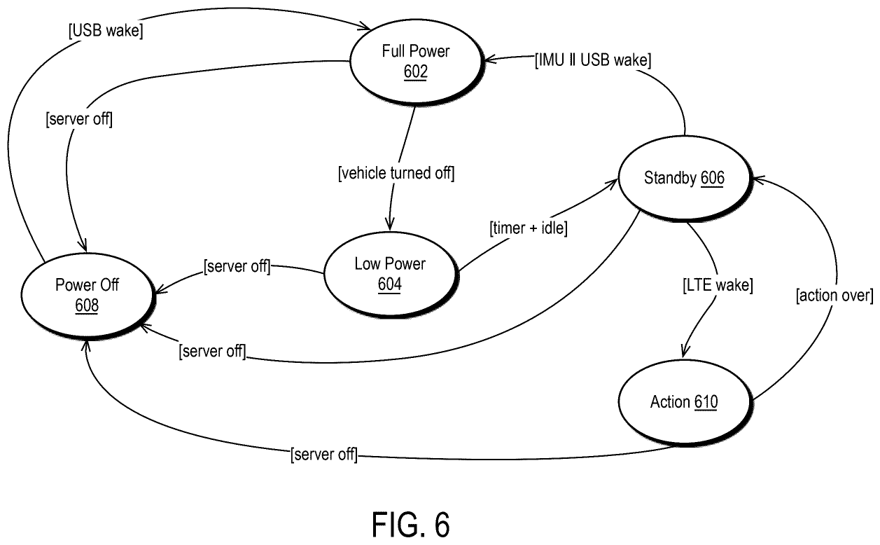

In some implementations, power management circuit 306 may comprise a low-power circuit that can be configured to detect the vehicle power state. In some implementations, power management circuit 306 can be configured to transmit a signal to the vehicle gateway that indicates this power state. As illustrated, this message may be packetized via packetization process 312 as well. As will be discussed in FIGS. 6 through 8, this detection can be used by the vehicle gateway to manage the power of the gateway and/or the entire system.

In some implementations, power management circuit 306 can monitor the power state of the vehicle by checking the voltage level at the diagnostic port, which may indicate whether the vehicle is on or off. In some implementations, power management circuit 306 may comprise a digital circuit to ascertain the power state. In some implementations, power management circuit 306 could communicate with the vehicle gateway to transmit the power state information, enabling the gateway to adjust its operations based on whether the vehicle is on or off. In some implementations, power management circuit 306 might have a minimalistic design to keep the VIA 104 lightweight and cost-effective, focusing solely on determining the on/off state of the vehicle. In some implementations, power management circuit 306 may utilize a logic circuit to detect the power state, which could ensure a reliable and prompt detection with minimal power consumption on its own. In some implementations, power management circuit 306 could be integrated into other components of the VIA 104 to minimize the space and resources required. In some implementations, power management circuit 306 might have a bypass feature to allow for manual override in scenarios where the automatic detection may not function as intended. In some implementations, power management circuit 306 may also have a status indicator, such as an LED, to provide a visual indication of the power state of the vehicle at the diagnostic port.

In some implementations, cable detection circuit 308 can be configured to receive an identifier of a cable from cable 114. As discussed, this may comprise the cable's “best guess” as to what diagnostic port is being used. In some implementations, the VIA 104 can include multiple firmware libraries corresponding to different types of diagnostic ports. As such, VIA 104 can be used in multiple types of vehicles regardless of the diagnostic ports. Thus, the VIA 104 (which is more complex and costly than cable 114) can be reused across vehicles and only requires a less complex and expensive vehicle-specific cable. As discussed, in some implementations, the VIA 104 may use the output of cable detection circuit 308 to load a candidate set of firmware for processing diagnostic port signals. In some implementations, VIA 104 can then inspect incoming packets to make a final decision of what diagnostic port is being used. In some implementations, VIA 104 can include “common” code that can be used for a set of potential diagnostic ports and can use this common code to bootstrap the decision on which set of “specific” firmware code to use.

FIG. 4 is a block diagram illustrating a vehicle gateway according to some of the disclosed embodiments.

In an implementation, a VG 108 is communicatively coupled to a vehicle via an input port 412. In some implementations, input port 412 comprises a USB port connected to a VIA (e.g., VIA 104) directly or via a hub (e.g., hub 106). In some implementations, input port 412 might include additional pins or connectors to facilitate other types of connections or to provide redundancy. In some implementations, input port 412 could include built-in circuitry to protect against electrical transients or interference that might affect the data transmission between VIA 104 and VG 108. In some implementations, input port 412 might feature a locking mechanism to ensure a secure physical connection with VIA 104 or hub 106, preventing accidental disconnections.

As discussed, VG 108 receives vehicle data and power indicators from VIA 104 via input port 412. VG 108 can further include one or more dashcams 410, a network interface 408, an IMU 406, a controller 404, and a power management circuit, PMC 402.

In some implementations, PMC 402 can manage a state machine to manage the power states of VG 108 and potentially other devices connected via the hub. This state machine might transition VG 108 and connected devices to various power states such as low power, sleep, or off, based on predefined or dynamically assessed conditions. In some implementations, PMC 402 might have logic circuits or firmware to process events or signals that trigger transitions between different power states. These events could be internal, such as a command from controller 404, or external, like a signal received from VIA 104 concerning the vehicle's power state. In some implementations, PMC 402 could communicate with hub 106 to coordinate the power management of devices connected through the hub, ensuring a coherent power management strategy across the system. In some implementations, PMC 402 might have memory to store power management profiles or histories, aiding in making informed decisions for transitioning between power states. In some implementations, PMC 402 may possess a user interface or be configurable through a network interface, allowing for customization of power management settings. In some implementations, PMC 402 could generate logs or alerts concerning the power state transitions, which might be useful for troubleshooting or analyzing the power management performance. In some implementations, PMC 402 might incorporate timing circuits to control the duration of time VG 108 or connected devices spend in different power states, ensuring timely transitions to active states when required. Further details on managing power states are provided in the descriptions of FIGS. 6 through 8.

In some implementations, controller 404 could primarily function as the central processing unit (CPU) of VG 108, executing instructions and managing the operations of the other components within VG 108. In some implementations, controller 404 might comprise multiple devices such as a standard CPU along with an Artificial Intelligence (AI) accelerator to enhance processing capabilities especially for tasks involving machine learning or deep learning algorithms. In some implementations, the AI accelerator may be implemented as one or a combination of central processing unit (CPU), graphics processing unit (GPU), or digital signal processor (DSP) devices. In some implementations, controller 404 could coordinate with PMC 402 to manage power states based on the processing demands or other operational parameters. In some implementations, controller 404 might have a memory to store instructions, data, or power management profiles necessary for the operation of VG 108. In some implementations, controller 404 may have interfaces to communicate with other components of VG 108 like IMU 406, network interface 408, and dashcams 410, facilitating data exchange and operational synchronization. In some implementations, controller 404 could support firmware updates to enhance or expand the capabilities of VG 108 over time.

In some implementations, IMU 406 could measure the motion-related parameters of the vehicle such as acceleration, angular rate, and magnetic field, providing essential data on the vehicle's dynamics. In some implementations, IMU 406 might consist of a combination of accelerometers, gyroscopes, and magnetometers to capture a comprehensive set of motion data. In some implementations, IMU 406 could interface with controller 404 to provide real-time motion data, which might be used for various applications including vehicle diagnostics, driver assistance systems, or event detection. In some implementations, the data from IMU 406 might be used as a triggering event for PMC 402; for example, detecting a sudden acceleration or deceleration could trigger PMC 402 to transition VG 108 to a different power state to capture critical data. In some implementations, IMU 406 may have built-in filters to reduce noise and improve the accuracy of the motion data. In some implementations, IMU 406 could support various communication protocols to transmit motion data to other components within VG 108 or external systems. In some implementations, IMU 406 may include self-diagnostic features to verify its operational status and ensure the reliability of the motion data.

In some implementations, controller 404 could function as an Electronic Logging Device (ELD) to record essential metrics pertaining to vehicle usage, driver behavior, and other operational parameters. The controller might capture and log data such as driving hours, vehicle speed, engine status, fuel consumption, and maintenance alerts, among others. In some implementations, this recorded data can be structured in a log format compliant with regulatory or organizational standards, ensuring adherence to legal and operational requirements. In some implementations, controller 404 might have a dedicated memory to securely store the logged data for a specified period or until it is uploaded to a central system. Periodically, or upon certain triggering events, controller 404 could initiate the transmission of the logged data to a central system via network interface 408. This central system could be a server managed by a fleet operator, a regulatory body, or a third-party service provider. In some implementations, the uploading process might be scheduled during low-traffic hours or while the vehicle is at rest to minimize the impact on network resources and vehicle operations. In some implementations, controller 404 may encrypt the data before transmission to ensure its integrity and confidentiality during transit. Furthermore, in some implementations, controller 404 might receive updates or instructions from the central system concerning logging parameters, operational thresholds, or firmware updates, enabling continuous alignment with evolving operational or regulatory requirements.

In some implementations, network interface 408 could provide cellular connectivity to VG 108, enabling communication over 4G, 5G, or other cellular standards with external networks or systems. In some implementations, network interface 408 might be capable of receiving signals or commands from a server even when VG 108 is in a low power, standby, or off state, to trigger transitions to a higher or lower power state based on the content of the received command. For instance, a command from a server could transition VG 108 from standby to active to perform a specified task, then revert back to standby or another lower power state upon completion. In some implementations, the commands received via network interface 408 could include instructions requesting a task to be performed, enabling VG 108 to wake up, execute the task, and then return to a lower power state, optimizing power consumption while ensuring required tasks are performed promptly. In some implementations, network interface 408 may have built-in security features to ensure the integrity and confidentiality of the communications. In some implementations, network interface 408 could support multiple cellular standards or fallback to lower generation cellular standards in areas with limited connectivity, ensuring reliable communication. In some implementations, network interface 408 might have the ability to report the status or results of the executed tasks back to the server, providing feedback or data necessary for further actions or analysis.

In some implementations, dashcams 410 could comprise one or more cameras positioned to capture video footage of the road ahead, assisting in tasks such as lane detection, traffic sign recognition, or license plate recognition through AI algorithms. These outward-facing cameras might employ advanced imaging technologies and AI processing to provide real-time insights or alerts regarding the road conditions, traffic, or potential hazards. In some implementations, dashcams 410 might also include one or more cameras directed inwards to monitor the driver and the cabin, aiding in distracted driving detection, driver identification, or other in-cabin AI analytics. These inward-facing cameras could employ facial recognition, gaze tracking, or other AI-driven analyses to assess the driver's attention, behavior, or other relevant factors, promoting safety and adherence to driving regulations. In some implementations, dashcams 410 may be capable of recording and storing video data for later analysis or evidence in case of incidents. In some implementations, dashcams 410 could have the ability to stream video data to external systems via network interface 408 for remote monitoring, analysis, or storage. In some implementations, dashcams 410 might have integrated lighting or infrared capabilities to ensure clear video capture under varying lighting conditions. In some implementations, dashcams 410 may work in coordination with controller 404 and other components of VG 108 to synchronize video capture with other data collection or processing tasks, facilitating comprehensive analysis and decision-making. In some implementations, dashcams 410 might support various video resolutions, frame rates, or compression algorithms to optimize video quality and storage efficiency based on the requirements of the AI analyses or other operational needs.

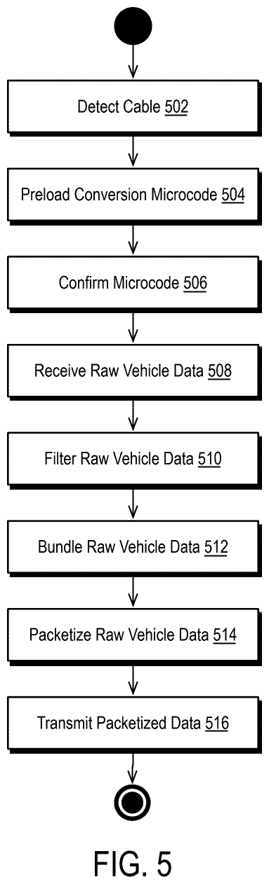

Functional aspects of the above-described system and individual components are described next more fully with respect to FIGS. 5 through 8.

FIG. 5 is a flow diagram illustrating a method for initializing a vehicle interface adapter and transmitting data to a vehicle gateway according to some of the disclosed embodiments. In some implementations, the method of FIG. 5 may be performed by a VIA (e.g., VIA 104).

In step 502, the method can include detecting a cable attachment.

In some implementations, step 502 can include involve monitoring a physical connection between the diagnostic port of the vehicle and the VIA via a cable (e.g., cable 114). Monitoring could be conducted through electrical signaling or monitoring circuitry designed to sense the presence of a connected cable. In some implementations, this detection could trigger an interrupt or a status flag within the system signaling that a cable has been attached. Upon detecting the cable attachment, the method can then initiate the necessary processes to establish communication with the vehicle's diagnostic port. This step can include identifying the type of cable and, by extension, the diagnostic port type to which it is connected, leveraging the cable detection circuit 308 in VIA 104. In some implementations, detecting the cable attachment could also trigger a self-test or diagnostic routine within the VIA to ensure that the connection is sound and that the necessary hardware and software resources are in a ready state to proceed with the initialization process. The detection of cable attachment might also trigger alerts or status updates to other components within the system or to a central management system, indicating that the VIA is transitioning to an active state.

In step 504, the method can include preloading protocol conversion microcode. As discussed, this microcode can comprise an initial “general” microcode that can bootstrap loading a second stage, port-specific microcode as will be discussed.

In some implementations, step 504 may involve loading a set of initial instructions or firmware—referred to as “general” microcode—into the VIA's memory. The general microcode could contain basic routines and protocols that facilitate initial communication with the diagnostic port and enable the identification of the specific diagnostic port type, such as a sub-type or sub-classification.

In some implementations, this microcode preload could be initiated automatically upon detecting cable attachment. The preload process might include transferring microcode from a non-volatile storage medium within the VIA to an execution memory, such as RAM, from where it can be accessed and executed by the VIA's controller or CPU. The general microcode might encapsulate a variety of basic protocols or communication routines that allow the VIA to interact with different types of diagnostic ports to a limited extent. This extent might be enough to ascertain the specific type of diagnostic port and determine the need for additional, port-specific microcode.

In some implementations, the preloaded general microcode could also include routines for error handling, logging, or reporting, which could be useful in the event of issues during the initialization process. The general microcode might also encompass routines for validating the integrity and correctness of the preloaded microcode to ensure it's free of errors and ready for execution. Additionally, the preloading process might involve setting up initial configurations, initializing buffers, or establishing basic communication channels between the VIA and other components within the system, laying the groundwork for the subsequent steps of the method.

In step 506, the method can include confirming that necessary microcode needed. In some implementations, this can be confirmed based on analyzing data received from the diagnostic port and identifying the specific “second stage” microcode required for further processing.

In some implementations, the step of confirming the necessary microcode may be performed after preloading the general microcode. This step might entail analyzing the data received from the diagnostic port to ascertain the specific diagnostic port type and, consequently, the additional microcode required for communication and data processing. In some implementations, the analysis could be performed by the general microcode already loaded into the VIA 104. This analysis might involve interpreting initial signals or messages received from the diagnostic port, or even sending queries to the diagnostic port and evaluating the responses. This process can then identify unique characteristics or signatures associated with particular diagnostic port types.

Once the diagnostic port type is identified, the VIA could then determine the specific “second stage” microcode that needs to be loaded to handle the protocols and data formats associated with that diagnostic port type. In some implementations, this determination could be done by referring to a lookup table or similar structure that maps diagnostic port types to corresponding microcode files. In some implementations, if the required microcode is not already present in the VIA's memory, the VIA might initiate a process to load the necessary microcode from an onboard storage or even download it from a remote server via a network connection. This process could involve validating the new microcode's integrity, such as through checksum verification or digital signature validation, before loading it into the execution memory. In some implementations, confirming the necessary microcode might also involve setting up or reconfiguring the communication channels, buffers, or other system resources in accordance with the requirements of the specific diagnostic port type and the newly loaded microcode.

In step 508, the method can include receiving raw vehicle data via the diagnostic port.

In some implementations, this step 508 initiates the data pipeline functionality of the VIA. In some implementations, receiving raw vehicle data could entail establishing a communication link between the VIA and the diagnostic port, facilitated by the previously loaded microcode tailored for the specific diagnostic port type. This communication link might follow protocols and standards associated with the diagnostic port, ensuring accurate and reliable data transmission. In some implementations, the data received might encompass a wide array of vehicle metrics, statuses, and diagnostics from various subsystems within the vehicle, such as the engine control unit, transmission, brakes, and others. The raw data might be encapsulated in messages or frames defined by the communication protocols of the diagnostic port.

In some implementations, the VIA might employ buffering mechanisms to temporarily store the incoming data, ensuring that no data is lost during periods of high data throughput or if processing delays occur. These buffering mechanisms might include circular buffers, FIFO (first-in, first-out) queues, or other data storage structures that can accommodate the flow of incoming data. Furthermore, in some implementations, as the data is being received, error detection and correction mechanisms might be employed to identify and rectify any transmission errors, ensuring the integrity of the data. This could involve utilizing checksums, parity bits, or other error-detecting/correcting codes associated with the communication protocols of the diagnostic port.

In some implementations, the receiving process might also include timestamping the incoming data or associating metadata with the data, which could be essential for subsequent processing, analysis, or auditing. This metadata might include information regarding the source of the data within the vehicle, the time of data acquisition, and other relevant details.

In step 510, the method can include filtering the raw vehicle data.

In some implementations, filtering allows the method to manage the volume of data and ensure that only relevant information is forwarded to subsequent stages of processing. In some implementations, the filtering could be executed based on predefined criteria, rules, or algorithms encoded within the microcode running on the VIA. In some implementations, the criteria for filtering could be dynamically adjusted or fine-tuned based on real-time conditions, historical data trends, or commands received from external systems. This dynamic adjustment might help maintain the relevance and efficiency of the filtering process over time.

In some implementations, the filtering process might involve categorizing the incoming data based on various attributes such as source, type, or priority. This categorization could assist in applying different filtering criteria to different categories of data. Furthermore, in some implementations, the filtering process could include error detection mechanisms to identify and possibly correct or discard erroneous data, ensuring the quality and reliability of the data being processed.

In some implementations, the filtering process might also entail aggregating or summarizing data, transforming multiple raw data points into a more compact or representative form. This could help reduce the data volume while preserving essential information. In some implementations, various feature engineering processes can be employed to aggregate and/or summarize data. In some implementations, metadata might be associated with the filtered data to retain context or provide additional information for subsequent processing stages. This metadata could include details about the filtering process, such as the criteria applied, the number of data points filtered, or timestamps indicating when the filtering occurred. In some implementations, filtered/modified data can be transmitted along with the original data.

In step 512, the method can include (optionally) bundling the raw vehicle data.

In some implementations, following the filtering process, the method may include a bundling step where the filtered data is aggregated into bundles. This step could be useful in managing the data transmission rate and ensuring efficient utilization of the communication channels. In some implementations, the bundling could occur over specified time intervals, where all the filtered data received during each interval is aggregated into a single bundle. The time intervals might be fixed or dynamically adjustable based on factors such as the current data rate, network conditions, or processing capacity.

In some implementations, the bundling process might categorize the data based on certain criteria such as data type, source, or priority before aggregating them into respective bundles. This categorization could help in maintaining a logical organization of the data and facilitating subsequent processing. In some implementations, each bundle created might be accompanied by header information that provides metadata about the contents of the bundle. This metadata might include details such as the number of data items in the bundle, the time interval over which the data was collected, or identifiers indicating the categories of data contained in the bundle. Furthermore, in some implementations, the bundling process could include mechanisms for ensuring the integrity and consistency of the data within each bundle. This might involve appending checksums, cryptographic hashes, or other data integrity checks to each bundle. In some implementations, buffer management strategies might be employed to handle scenarios where the incoming data rate temporarily exceeds the bundling capacity, ensuring that no data is lost during high-throughput periods.

In step 514, the method can include packetizing the raw vehicle data.

In some implementations, step 514 includes converting the bundled or filtered vehicle data into a packet format suitable for transmission over USB (or similar) interfaces. The process of packetizing essentially encapsulates the data into packets conforming to the USB (or similar) protocol standards, preparing it for transmission to the vehicle gateway or other connected devices.

In some implementations, the packetization process could include appending necessary header and footer information to each data packet. This information might encompass fields such as source and destination addresses, packet length, sequence numbers, and error-checking codes like checksums or CRCs. This encapsulation ensures that the data packets adhere to the USB protocol specifications, facilitating accurate and reliable data transmission. In some implementations, the packetization process might involve segmenting larger data bundles into smaller packets if the size of the data exceeds the maximum packet size defined by the USB standards. This segmentation ensures that each packet remains within the allowable size limits, adhering to the protocol specifications.

Additionally, in some implementations, the packetization process might include a mechanism for handling packet sequence numbering and retransmission of lost or erroneous packets. This mechanism could enhance the reliability of the data transmission, ensuring that all data is accurately delivered to the destination. In some implementations, the packetization process might also incorporate a mechanism for flow control, managing the rate at which packets are transmitted to avoid overwhelming the receiving device or congesting the communication channel.

In step 516, the method can include transmitting the packetized data to a device such as a hub (e.g., hub 106) or vehicle gateway (e.g., VG 108).

In some implementations, step 516 includes transmitting the packetized data to a designated device such as a vehicle gateway (e.g., VG 108) or a hub (e.g., hub 106). The transmission could be facilitated via the USB interface, utilizing the established communication protocols and channels. This step marks the final phase of the data handling process within the VIA, transitioning the packetized data out of the VIA to the intended recipient for further processing or analysis.

FIG. 6 is a state diagram illustrating power states of a vehicle gateway and transitions between such states.

In FIG. 6, various states of the system are depicted. In some implementations, these states may represent the state of the vehicle gateway. In other implementations, the states may encompass both the vehicle gateway and one or more other components, such as the hub or the VIA.

The states include a full power state 602, where the system consumes as much power as needed to perform all functions or operations and power all subcomponents. This state represents the scenario requiring the most power consumption from the vehicle, which delivers the power from its battery.

The states also include a low power state 604. In this state, many components of the system are powered off, and only critical or specifically designed components are left powered on. As a result, the system consumes significantly less power than in the full power state 602.

The states also include a standby state 606. In this state, even fewer components of the system are powered on, and only critical components remain active.

The states also include a power off state 608. In this state, power is essentially disconnected from the system, and thus no components are consuming any power from the vehicle battery. In some implementations, battery power may be used to power some components within the system.

Lastly, the states include an action state 610. In this state, the system powers on selected components or a smaller subset of components to perform a specific action as requested by an external device or an internal subsystem, as will be discussed. In some implementations, the action state 610 may be omitted. In these implementations, the method may alternatively transition from standby state 606 to full power state 602 in response to an LTE wake command. In this implementation, any actions received over a network may be performed in full power state 602 in lieu of in action state 610.

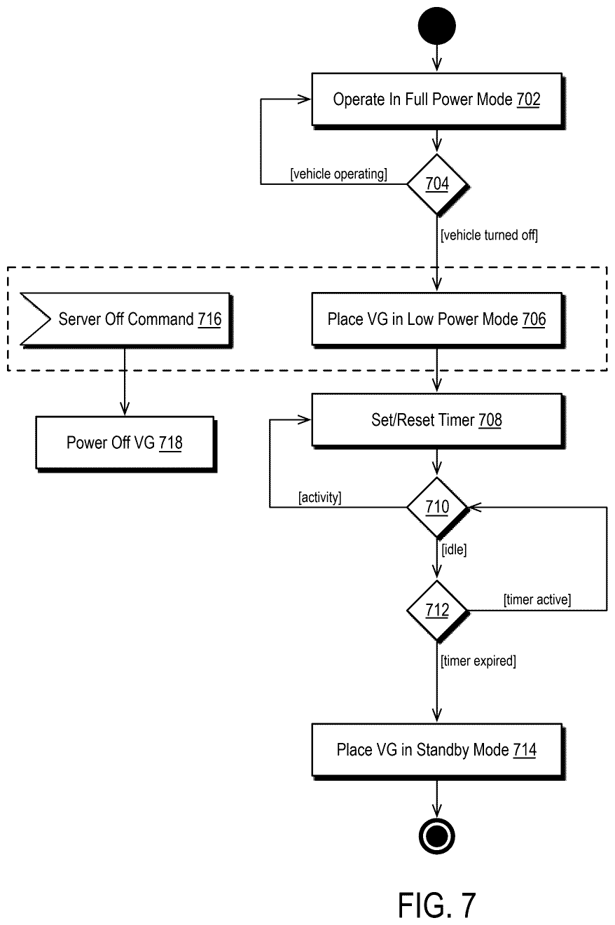

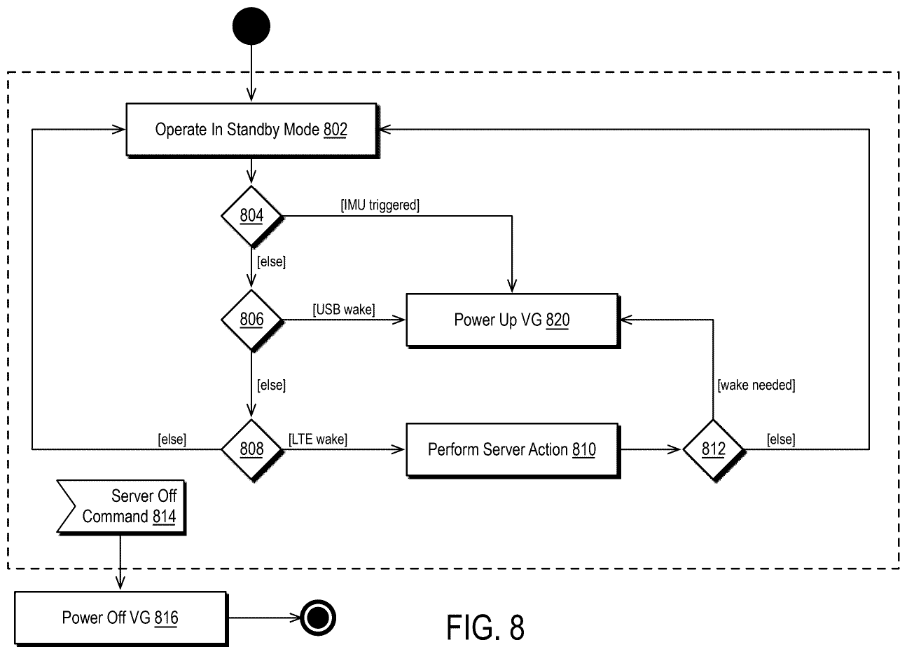

Next, an explanation of the state transitions and conditions is provided. The following description provides a high-level overview of the transitions and references made to FIGS. 7 and 8, which provide further detail. For purposes of explanation, it is assumed that the vehicle will begin in a powered-on state, although, as will be illustrated, the process may be entered via other states.

In general, the system will remain in a full power state 602 until the vehicle is turned off. As discussed, the VIA can detect this power off by reading the data from the diagnostic port and can then transmit a packet to the vehicle gateway to signal that the vehicle has been turned off (e.g., the ignition has been turned to an off state). In response, the system will transition to a low power state 604 given that the vehicle has turned off, and the battery is no longer being charged by the alternator. This results in less power consumption of the system, as many subsystems will be powered off.

The vehicle will remain in the low power state 604 until a timer expires and no activity is detected. This can include setting a timer that measures a predefined duration and also monitors for any specific activities that would require maintaining its low power state. For example, the vehicle gateway may monitor for any user interactions or any vehicle events that indicate that the vehicle is still being used although the ignition has been turned off. If, when in the low power state 604, the timer expires and no action has been detected, the system may transition to the standby state 606.

When in the standby state 606, various actions can occur that will transition the system to another state. In one scenario, the vehicle gateway may receive data from the IMU, which indicates that the vehicle has moved, or it may receive USB data from the VIA device, causing it to wake up. In this scenario, the vehicle gateway will transition to the full power state 602 to provide full access to all systems. Alternatively, or in conjunction with the foregoing, the vehicle gateway may include a global navigation satellite system (GNSS) receiver (e.g., a Global Positioning System receiver) that can be used to determine if a vehicle has moved. Specifically, a GNSS receiver can be used to detect that a vehicle has moved past a designated geofence, which indicates that the vehicle has moved. In some implementations, the GNSS received can be used in conjunction with an IMU to provide backup or redundancy assurances to detect vehicle movement.

In another scenario, the vehicle gateway may receive a command from a central server to perform an action. This is also referred to as the LTE wake signal. In this scenario, the central server issues a network message to the vehicle gateway that includes parameters of an action or function to be invoked or executed on the vehicle gateway. In response to this command, the vehicle gateway may transition to the action state 610, where it can perform the action. For example, an action may comprise reading the electronic logging data and transmitting the logging data back to the central server. Certainly, other actions are envisioned. Once the system performs the action, the system will transition back into the standby state 606. Alternatively, the system may still be able to receive other server actions, indicating that the device transition to the power off state 608, and it will do so when receiving one.

As illustrated in FIG. 6, when in the low power state 604, the system may also receive a server off command in some implementations. The server off command refers to a network message received from a central system that instructs the system to transition to a power off state 608. Thus, in some embodiments, in the low power state 604, the network interface of the vehicle gateway may still be active and capable of receiving commands from a network, allowing the central system to turn the entire system off by entering the power off state 608.

As illustrated, the system will generally only transition to the power off state 608 in response to a server off command. However, in some embodiments (not illustrated), the system may further include a separate timer for determining when it is safe to transition to the power off state 608, based on a level of inactivity in the vehicle. In the power off state 608, the system will only transition to the full power state 602 in response to a USB wake command. In general, the USB wake command can be triggered upon the user of the vehicle starting the ignition and thus causing the VIA to transmit a signal indicating the vehicle has started, and power can be consumed from the vehicle's battery.

The foregoing provides a brief overview of the transition between states within the system. The following FIGS. 7 and 8, provide further details on the operation of the various devices to implement the above state machine.

FIG. 7 is a flow diagram, illustrating a method for a transitioning a vehicle gateway from a full power state to a standby state, according to some of the disclosed embodiments.

In step 702, the method can include operating in a full power state. In this state, the system powers on all subcomponents and devices within the system, allowing them to operate at full capacity. In the full power state, the system draws electricity from the battery of the vehicle via the diagnostic port, the VIA, and potentially the hub. This state represents the maximum power consumption state of the system and enables all functionalities. The system generally aims to reduce its power consumption as much as possible while still providing the necessary functions needed.

In step 704, the method can include determining if the vehicle is operating. As used herein, “operating” refers to the vehicle's ignition being started and power flowing through the diagnostic port from the battery, with the alternator configured to charge the battery. In this state, the system essentially treats the battery as an unlimited power supply. However, in alternative implementations (not illustrated), the system can also monitor the battery health and decide whether to proceed to step 706 based on the health of the battery, despite the vehicle running. For instance, the system could measure the voltage of the battery to ascertain the amount of charge remaining, and if the battery voltage falls below a predetermined threshold, the system may move to step 706, regardless of the vehicle running.

In step 706, the method transitions the vehicle gateway (and potentially other components, such as the VIA or hub) into a low power state. In this state, the components power down some or many of the subcomponents of the devices. Subcomponents in the low power state may draw power from the battery and thus remain capable of responding to commands or instructions. For example, the vehicle gateway may disable the dashcam devices and associated hardware but may provide power to the IMU sensor and the network interface. The specific selection of devices that remain active in low power mode may be configured on the vehicle gateway.

As illustrated in FIG. 7, the method may include receiving a server off command in step 716. This may be an interrupt procedure, whereby a central system transmits a network packet to the vehicle gateway specifying that the vehicle gateway should be turned off completely. In some implementations, such a command could be used by a centralized operator to proactively turn off a vehicle gateway within a vehicle. In this scenario, the central operator may address the network packet to a specific vehicle and transmit the command to that vehicle. In response, the method proceeds to step 718, wherein the vehicle gateway transitions to the power off state. In the power off state, the vehicle gateway is effectively severed from the battery, and all components of all systems are powered off. Components such as the network interface and the IMU sensor, which receive power during the low power state, are disconnected from a power source. In implementations, the VIA device may include a small battery, such as a CMOS battery, that enables it to detect the next time the vehicle is started. When the vehicle is started, the VIA device will receive that signal via the diagnostic port and can transmit a USB command to the vehicle gateway, causing it to power on, as will be discussed. Since step 716 is an interrupt-driven process, it may occur at any time during the low power state.

While in the low power state, the method proceeds to step 708, wherein a timer is set to specify how long the system should remain in the low power state. In some implementations, this timer may comprise a fixed duration, set by the vehicle gateway. In other implementations, the timer can be dynamically chosen based on a variety of factors related to the system. For example, the timer may be specified based on the battery health or based on a historical log of power transitions of the system.

After setting the timer in step 708, the method proceeds to steps 710 and 712. In step 710, the method determines if an action was taken that merits keeping the system in a low power state. For instance, the system may detect movement via the IMU sensor, or network activity via the network interface, and classify these as actions that merit staying in the low power state. If no actions are occurring, the system checks in step 712 whether the timer has expired. If the timer has not expired, the system continues to operate in low power mode in step 708 and continues to monitor for actions in step 710.

Once the timer has expired, the method proceeds to step 714, where the vehicle gateway is placed into a standby state. Step 710 and step 712 operate as a two-condition check to ensure first that no actions are still being performed and second that the timer has expired. When both conditions are satisfied, the system will safely place the vehicle gateway into a standby state as no actions have occurred, and a sufficient amount of time has elapsed.

FIG. 8 is a flow diagram, illustrating a method for transitioning a vehicle gateway, from a standby state to more other states, according to some of the disclosed embodiments.

In step 802, the method can include operating the vehicle gateway in a standby state. As discussed in the description of FIG. 7, the standby state can include powering down most of the components of the vehicle gateway, except for those that are deemed critical for transitioning to other states. In one implementation, at least two of these components that remain powered on (either at full power, or at reduced power) are the network interface and the IMU sensor. In other implementations, other subcomponents can remain powered on fully, or powered on at reduced capacity.

In step 804, the method can include determining if the IMU sensor was triggered. In some implementations, the IMU sensor can be triggered when there is a movement of the vehicle gateway detected. In some implementations this IMU sensor can be selected such that it only detects true movements of the vehicle gateways versus rapid acceleration without meaningful horizontal or vertical movement. For example, many IMU sensors will detect rapid acceleration from very small movements, such as finger taps, or other small, but highly accelerating movements. The IMU sensor employed in the vehicle gateway can be selected such that only true movements of the vehicle gateway, and thus the vehicle, are detected as triggers. Generally if the method detects a movement of the vehicle gateway, this may indicate that the vehicle is being moved, and the system should be powered on to monitor the vehicle's movement.

As such, the method will then move to step 820, where the vehicle gateway is transitioned to a full power state. Details of the full power state were provided in the previous figures and are not repeated here in. In general, in the full power state all components of the vehicle gateway are receiving power and able to perform their functions.

In step 806, the method can alternatively include determining if a USB wake signal has been received by the vehicle gateway. In some implementations, the VIA generates a USB wake signal. In some implementations, the VIA device will generate this USB signal in response to detecting a power signal received from the battery via the diagnostic port. The VIA will transmit a USB wake signal upon detecting that the vehicle has started and power has been provided from the battery through the diagnostic port into the VIA. In some implementations, this USB signal may comprise a standard-compliant USB signal generated by the packetization procedure in the VIA. If the vehicle gateway receives a USB wake signal, the method proceeds to step 820 where the vehicle gateway is again fully powered on.

In step 808, the method, alternatively can include determining if an LTE signal was received. In some implementations, the LTE signal may comprise a network packet, transmitted from a remote endpoint, such as a central platform, communicatively coupled to the vehicle gateway via the network interface, and a cellular network. In alternative implementations, a Wi-Fi network can be used in place of a cellular network, where a mobile device can transmit a Wi-Fi signal, in lieu of an LTE signal. In such a scenario, a Wi-Fi transceiver may be powered on during the standby state to receive this signal.

In one implementation, the LTE signal may simply indicate that the vehicle gateway should be powered on. In such a scenario (not illustrated) the method can proceed to step 820 and fully power on the vehicle gateway. Such a command is similar but the opposite of the server off command discussed in FIG. 7.

Alternatively, or in conjunction with the foregoing, the LTE signal can include an action to perform on the vehicle gateway. In some implementations, this action can be represented as a set of fields or an object serialized in the LTE packet. For example, the action may include parameters indicating the vehicle gateway should report its location via the network interface to the central server. As another example, the LTE command may include an action that specifies that the ELD data should be read and transmitted back to the central server.

In step 810, after receiving the LTE wake command, the method can include the vehicle gateway performing the requested action. In some scenarios, the vehicle gateway can perform the action without changing the power condition of the vehicle gateway. For example, the LTE action may simply be a ping request in which the vehicle gateway can respond with a pong message. Such an action does not require any other subcomponents requiring additional power. However, in other scenarios, the LTE action may require providing power to other components. For example, the LTE command may request that the vehicle gateway take an image of the interior of the vehicle. Such a command would require power to the interior facing dash cam, which was powered off in low power mode and continue to be powered off in standby mode. In such a scenario, the vehicle gateway can identify which components need power and can selectively enable power supply to those components. In some scenarios, the vehicle gateway can maintain a list of approved LTE actions, and a mapping to those subcomponents that need power to perform those actions enabling the vehicle gateway to selectively power up subcomponents, even while in standby mode.

After performing the action and step 810, the method proceeds to step 812. In this step, the method can include the vehicle gateway next determining if a full power on is needed. If so, the method proceeds to step 820 where the method can include powering on the vehicle gateway fully. In some scenarios, the LTE wake signal may include a flag indicating that the vehicle gateway should be turned on fully, if so, the method will proceed to step 820, and fully power on the vehicle gateway. In other scenarios, the vehicle gateway may determine on its own whether a full power is needed. For example, if the LTE action requests that the vehicle gateway determine if there has been any movement while in standby mode that did not trigger a full power on, and the vehicle gateway determines that there has been movement the method may proceed to step 820 to enable a deeper inspection of this movement in a fully powered state.

If the LTE action or the determination of the vehicle gateway does not indicate a full power on is needed the method may return to step 802, where the device is placed again in standby mode. In some implementations, this step can include selectively powering down any subcomponents that were powered on in step 810.

In some scenarios if none of the above triggers are detected in step 804, step 806, or step 808, the system returns to step 802, and remains in standby mode.

In some scenarios as in FIG. 7, the method can include receiving a server off command in an interrupt driven fashion in step 814. In response to such a server off command, the system transitions to a fully powered off state in step 816. Details of this process are similar to the server off command described in FIG. 7 and are not repeated here in for the sake of clarity.

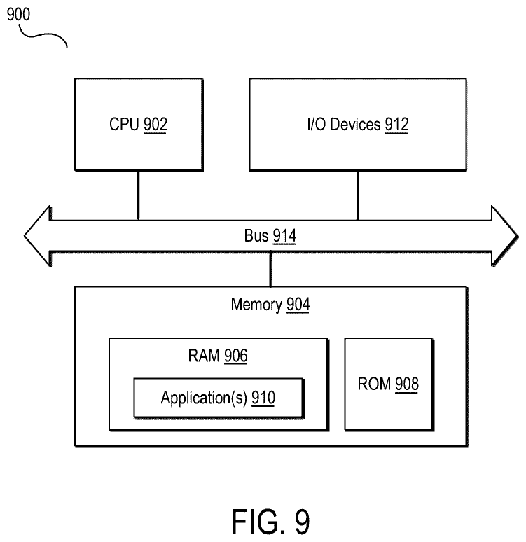

FIG. 9 is a block diagram of a computing device according to some embodiments of the disclosure.

As illustrated, the device 900 includes a processor or central processing unit (CPU) such as CPU 902 in communication with a memory 904 via a bus 914. The device also includes one or more input/output (I/O) or peripheral devices 912. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 902 may comprise a general-purpose CPU. The CPU 902 may comprise a single-core or multiple-core CPU. The CPU 902 may comprise a system-on-a-chip (SoC) or a similar embedded system. In some embodiments, a graphics processing unit (GPU) may be used in place of, or in combination with, a CPU 902. Memory 904 may comprise a memory system including a dynamic random-access memory (DRAM), static random-access memory (SRAM), Flash (e.g., NAND Flash), or combinations thereof. In one embodiment, the bus 914 may comprise a Peripheral Component Interconnect Express (PCIe) bus. In some embodiments, the bus 914 may comprise multiple busses instead of a single bus.

Memory 904 illustrates an example of a non-transitory computer storage media for the storage of information such as computer-readable instructions, data structures, program modules, or other data. Memory 904 can store a basic input/output system (BIOS) in read-only memory (ROM), such as ROM 908 for controlling the low-level operation of the device. The memory can also store an operating system in random-access memory (RAM) for controlling the operation of the device.

Applications 910 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 906 by CPU 902. CPU 902 may then read the software or data from RAM 906, process them, and store them in RAM 906 again.

The device may optionally communicate with a base station (not shown) or directly with another computing device. One or more network interfaces in peripheral devices 912 are sometimes referred to as a transceiver, transceiving device, or network interface card (NIC).

An audio interface in peripheral devices 912 produces and receives audio signals such as the sound of a human voice. For example, an audio interface may be coupled to a speaker and microphone (not shown) to enable telecommunication with others or generate an audio acknowledgment for some action. Displays in peripheral devices 912 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 912 may comprise any input device arranged to receive input from a user. An illuminator in peripheral devices 912 may provide a status indication or provide light. The device can also comprise an input/output interface in peripheral devices 912 for communication with external devices, using communication technologies, such as USB, infrared, Bluetooth®, or the like. A haptic interface in peripheral devices 912 provides tactile feedback to a user of the client device.

A GPS receiver in peripheral devices 912 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A system comprising:
a vehicle interface adapter, the vehicle interface adapter communicatively connected to a diagnostic port of a vehicle via a first cable; and
a vehicle gateway, the vehicle gateway communicatively coupled to the vehicle interface adapter via a second cable, wherein
the vehicle interface adapter is configured to receive vehicle data via the first cable, packetize the vehicle data into vehicle packets, and transmit the vehicle packets to the vehicle gateway, and
the vehicle gateway is configured to receive the vehicle packets and manage a power state of the system.

2. The system of claim 1, wherein the first cable includes a first end, the first end comprising a pinout for the vehicle interface adapter and a second end, the second end selected based on a type of the diagnostic port.

3. The system of claim 1, wherein the second cable comprises a universal serial bus cable.

4. The system of claim 1, wherein the first cable includes a detection integrated circuit configured to detect a type of the diagnostic port and transmit a signal to the vehicle interface adapter representing the type of the diagnostic port.

5. The system of claim 4, wherein the detection integrated circuit includes a fixed value set based on the type of the diagnostic port.

6. The system of claim 4, wherein the detection integrated circuit includes program logic to analyze signals received via the diagnostic port to identify the type of the diagnostic port.

7. The system of claim 4, further comprising a universal serial bus (USB) hub, the USB hub communicatively coupled to the vehicle interface adapter and the vehicle gateway, wherein the vehicle gateway acts a USB host.

8. The system of claim 4, wherein the vehicle gateway is configured to manage a power state of the system by transitioning the vehicle gateway among a plurality of power states including a full power state, low power state, standby state and power off state.

9. The system of claim 8, wherein the vehicle gateway is configured to perform an action received from a network while in the standby state.

10. The system of claim 8, wherein the vehicle gateway is configured to transition from the standby state to the full power state in response to an inertial measurement unit (IMU) event or a USB wake event.

11. A method comprising:
operating a vehicle gateway in a full power state;
detecting a change in an operating status of a vehicle communicatively coupled to the vehicle gateway;
transitioning the vehicle gateway to a low power state based on the change in the operating status;
transitioning the vehicle gateway to a standby stage after a timer expires;
receiving, by the vehicle gateway, a trigger signal while in the standby state; and
transitioning to one of a full power state or action state in response to the trigger signal.

12. The method of claim 11, wherein said detecting a change in vehicle operating status comprises detecting a vehicle ignition status or monitoring a health of a battery through a diagnostic port.

13. The method of claim 11, wherein the trigger signal comprises one or more of: a USB wake signal, an LTE signal, or an IMU sensor trigger indicating movement of the vehicle.

14. The method of claim 11, wherein transitioning the vehicle gateway to a standby stage after a timer expires further comprises confirming that an action was not detected before the timer expires.

15. The method of claim 11, wherein transitioning to the action state comprises performing an action included in a command received via a network interface.

16. A non-transitory computer-readable storage medium for tangibly storing computer program instructions capable of being executed by a computer processor, the computer program instructions defining steps of:
operating a vehicle gateway in a full power state;
detecting a change in an operating status of a vehicle communicatively coupled to the vehicle gateway;
transitioning the vehicle gateway to a low power state based on the change in the operating status;
transitioning the vehicle gateway to a standby stage after a timer expires;
receiving, by the vehicle gateway, a trigger signal while in the standby state; and
transitioning to one of a full power state or action state in response to the trigger signal.

17. The non-transitory computer-readable storage medium of claim 16, wherein said detecting a change in vehicle operating status comprises detecting a vehicle ignition status or monitoring a health of a battery through a diagnostic port.

18. The non-transitory computer-readable storage medium of claim 16, wherein the trigger signal comprises one or more of: a USB wake signal, an LTE signal, or an IMU sensor trigger indicating movement of the vehicle.

19. The non-transitory computer-readable storage medium of claim 16, wherein transitioning the vehicle gateway to a standby stage after a timer expires further comprises confirming that an action was not detected before the timer expires.

20. The non-transitory computer-readable storage medium of claim 16, wherein transitioning to the action state comprises performing an action included in a command received via a network interface.
